(19) United States
(12) Patent Application Publication
(10) Pub. No.: US 2025/0317160 A1
(43) Pub. Date: Oct. 9, 2025

(54) POWER-AMPLIFICATION LINEARIZATION METHOD USING MULTI-RATE HYBRID PREDISTORTION WITH REDUCED SAMPLING RATE AND RESOLUTION, AND APPARATUSES, SYSTEMS, AND NON-TRANSITORY COMPUTER-READABLE STORAGE DEVICES EMPLOYING SAME

(71) Applicant: HUAWEI TECHNOLOGIES CO., LTD., Shenzhen (CA)

(72) Inventors: Jiazhi Chen, London (CA); Pengyi Jia, London (CA); Xianbin Wang, London (CA); Ming Jian, Kanata (CA); Peyman Neshaastegaran, Stittsville (CA)

(21) Appl. No.: 18/625,523

(22) Filed: Apr. 3, 2024

(51) Int. Cl. H04B 1/04

(52) U.S. Cl. CPC H04B 1/0475; H04B 2001/0425

(57) ABSTRACT

A method for adaptively estimating distortion coefficients of a power amplifier for compensating distortion of the power amplifier, the method has the steps of: estimating the power-amplifier distortion coefficients based on a first digital signal for generating a radio-frequency analog signal through the power amplifier, and a second digital signal obtained from the radio-frequency analog signal. The first digital signal has a length adaptively variable based on a predefined distortion-estimation accuracy.

### FIELD OF THE DISCLOSURE

The present disclosure relates generally to power amplifiers, and in particular to power-amplification linearization method using multi-rate hybrid predistortion with reduced sampling rate and resolution, and apparatuses, systems, and non-transitory computer-readable storage devices for wireless communications employing same.

### BACKGROUND

Power amplifiers (PAs) play an important role in wireless communications, which amplify signals for transmission via one or more antennas. It is preferable that a PA provides a linear amplification within its operational bandwidth. However, PAs usually do not exhibit perfect linearity across the entire operational bandwidth. Therefore, PA linearization methods are often used for compensating for PA nonlinear distortions. For example, predistortion techniques may be used to intentionally apply distortion to an input signal to compensate for nonlinear distortions in amplification, resulting in a more linear output signal.

To meet the massive data rate requirement, future wireless communications such as the six-generation (6G) mobile networks may utilize up to GHz signal bandwidths while relying on mmWave, and even THz frequency bands, which lead to significant challenges for PA linearization as PAs may exhibit severe nonlinear distortions within such wide operational bandwidths.

To compensate for PA nonlinear distortions, some predistortion techniques, such as digital predistortion (DPD) methods and analog predistortion (APD) methods, have been widely explored as effective PA linearization approaches. Typically, successful PA linearization requires high sampling and processing rates (for example, 5 times of the signal bandwidth) in every module of the predistortion system (such as the baseband module, the transmitter (Tx) chain, the feedback loop, and the like), and requires high resolution of analog-to-digital converter (ADC) (such as 12-bit ADCs).

The implementation cost induced by the requirements of sampling and processing rates as well as resolution in some predistortion systems remains manageable for PA linearization. However, in future wireless communications such as the 6G mobile networks, predistortion for dramatically increased signal bandwidth and carrier frequency requires high sampling rate digital circuits in baseband module and high-speed, high-resolution ADC in the feedback loop, which may cause extremely challenging design and very high implementation cost.

It is therefore a desire to provide a novel PA linearization method with ease of design and/or reduced implementation cost.

### SUMMARY

According to one aspect of this disclosure, there is provided a first method for adaptively estimating distortion coefficients of a power amplifier for compensating distortion of the power amplifier, the method comprising: estimating the power-amplifier distortion coefficients based on a first digital signal for generating a radio-frequency analog signal through the power amplifier, and a second digital signal obtained from the radio-frequency analog signal; the first digital signal having a length adaptively variable based on a predefined distortion-estimation accuracy.

In some embodiments, said estimating the power-amplifier distortion coefficients comprising: iteratively generating the first digital signal by asynchronously accumulating an adaptively selected first set of samples for providing an averaging effect to achieve desired the predefined distortion-estimation accuracy, the first set of samples being a first number of samples of the first digital signal.

In some embodiments, said estimating the power-amplifier distortion coefficients comprising: downconverting the radio-frequency analog signal to a frequency lower than a carrier frequency of the radio-frequency analog signal to obtain a first analog signal; converting the first analog signal to the second digital signal with a sampling rate lower than a full sampling rate; estimating the power-amplifier distortion coefficients based on the first set of samples and a second set of samples, with the first set of samples being a first number of samples of the first digital signal and the second set of samples being the first number of samples of the second digital signal; calculating an estimation error of the estimated power-amplifier distortion coefficients; determining that the estimation error is larger than an estimation error threshold; and repeating said estimating the power-amplifier distortion coefficients step based on the first set of samples and the second set of samples, with the first set of samples being a second number of samples of the first digital signal and the second set of samples being the second number of samples of the second digital signal, the second number being greater than the first number.

In some embodiments, the second number of samples of the first digital signal comprises the first number of samples of the first digital signal, and the second number of samples of the second digital signal comprises the first number of samples of the second digital signal.

In some embodiments, the first method further comprises: adjusting a sampling rate of the first digital signal and/or the sampling rate of the second digital signal.

In some embodiments, the second digital signal has a resolution of less than 8 bits.

In some embodiments, the second digital signal has a resolution of 3 bits or 4 bits.

In some embodiments, a ratio D₃ of the full sampling rate over the sampling rate of the second digital signal is greater than one (1).

In some embodiments, a ratio D₃ of the full sampling rate over the sampling rate of the second digital signal is 100.

In some embodiments, said estimating the power-amplifier distortion coefficients based on the first set of samples and the second set of samples comprises: estimating the power-amplifier distortion coefficients using a least square method based on the first set of samples and the second set of samples.

In some embodiments, said estimating the power-amplifier distortion coefficients based on the first set of samples and the second set of samples comprises: estimating the power-amplifier distortion coefficients using a least square method based on the first set of samples and the second set of samples as:

$$\hat{G} = {( {Ω}^{H} Ω )}^{- 1} {Ω}^{H} Y$$

where Ĝ is a matrix of PQ×1 dimensions representing the power-amplifier distortion coefficients, Ω represents a basic function matrix with N×PQ dimensions and is formulated as:

$$Ω = {[ \begin{matrix}{w}_{0 , 0} ( x ( kn ) ) & {w}_{1 , 1} ( x ( kn ) ) & … & {w}_{P - 1 , Q - 1} ( x ( kn ) ) \\ {w}_{0 , 0} ( x ( k ( n + 1 ) ) ) & {w}_{1 , 1} ( x ( k ( n + 1 ) ) ) & … & {w}_{P - 1 , Q - 1} ( x ( k ( n + 1 ) ) ) \\ ⋮ & ⋮ & ⋱ & ⋮ \\ \begin{matrix}{w}_{0 , 0} ( x ( k ( n + \\ N - 1 ) ) )\end{matrix} & \begin{matrix}{w}_{1 , 1} ( x ( k ( n + \\ N - 1 ) ) )\end{matrix} & … & \begin{matrix}{w}_{P - 1 , Q - 1} ( x ( k ( n + \\ N - 1 ) ) )\end{matrix}\end{matrix} ]}_{N \times PQ} ,$$

where w_{p,q}(x(kn)) (0≤p≤P and 0≤q≤Q) indicates one of the interval samples of the PA input signal under p-th polynomial order and q-th memory depth, the basic function Ω comprises adjacent PA input samples obtained from the first digital signal, and

$$Y = {[ y ( kn ) , y ( k ( n + 1 ) ) , … , y ( k ( n + N - 1 ) ) ]}^{T} ,$$

representing the second set of N samples.

In some embodiments, the estimation error is a normalized mean square error (NMSE) between the second digital signal and an estimation of the second digital signal, calculated as:

$$NMSE = 10 {log}_{10} ( \frac{{\sum }_{n = 1}^{N} {‖ y ( n ) - \hat{y} ( n ) ‖}^{2}}{{‖ y ( n ) ‖}^{2}} ) ,$$

where y(n) represents the second digital signal, and ŷ(n) is the estimation of the second digital signal obtained as:

Ŷ=ΩĜ.

where Ŷ is a vector of the estimated PA output signal ŷ(n).

In some embodiments, the estimation error is a NMSE between the second digital signal and an estimation of the second digital signal; and the estimation of the second digital signal is obtained based on the first digital signal and the estimated power-amplifier distortion coefficients.

In some embodiments, the first digital signal is obtained from a third digital signal; and the first method further comprises: generating an estimation of the second digital signal based on the first digital signal and the estimated power-amplifier distortion coefficients, and training a plurality of predistortion coefficients based on comparison of the estimation of the second digital signal and the third digital signal.

In some embodiments, the first method further comprises: adjusting a sampling rate of the estimation of the second digital signal to match a sampling rate of the third digital signal.

In some embodiments, said training the plurality of predistortion coefficients comprises: calculating a first one of the plurality of predistortion coefficients based on a predistortion-coefficient weight determined based on the comparison of the estimation of the second digital signal and the third digital signal; and obtaining each subsequent one of the plurality of predistortion coefficients based on a previous one of the plurality of predistortion coefficients and the predistortion-coefficient weight.

In some embodiments, the third digital signal is obtained by oversampling an input digital signal by a first oversampling factor D₁.

In some embodiments, D₁ is lower than a Nyquist rate of the radio-frequency analog signal.

In some embodiments, D₁ is less than 5.

In some embodiments, D₁ is 2, 3, or 4.

In some embodiments, the first method further comprises: introducing digital predistortion into the third digital signal using a memoryless predistortion function with the plurality of predistortion coefficients to obtain the first digital signal; oversampling the first digital signal by a second oversampling factor D₂ to obtain a fourth digital signal; obtaining a second analog signal from the fourth digital signal; upconverting the second analog signal to a radio frequency to obtain a third analog signal; and introducing analog predistortion into the third analog signal using a memory polynomial predistortion function with the plurality of predistortion coefficients to obtain a fourth analog signal for inputting to the power-amplifier for obtaining the radio-frequency analog signal for transmission.

In some embodiments, a multiplication of D₁, D₂, and a sampling rate of the input digital signal is greater than or equal to the full sampling rate.

According to one aspect of this disclosure, there is provided a second method comprising: oversampling an input digital signal by a first oversampling factor D₁ to obtain a first digital signal; introducing digital predistortion into the first digital signal to obtain a second digital signal; oversampling the second digital signal by a second oversampling factor D₂ to obtain a third digital signal; obtaining a first analog signal from the third digital signal; upconverting the first analog signal to a radio frequency to obtain a second analog signal; and introducing analog predistortion into the second analog signal to obtain a third analog signal for inputting to a power amplifier for obtaining a radio-frequency analog signal for transmission.

In some embodiments, D₁ is lower than a Nyquist rate of the radio-frequency analog signal.

In some embodiments, D₁ is less than 5.

In some embodiments, D₁ is 2, 3, or 4.

In some embodiments, a multiplication of D₁, D₂, and a sampling rate of the input digital signal is greater than or equal to the full sampling rate.

In some embodiments, said introducing the digital predistortion into the first digital signal comprises: introducing the digital predistortion into the first digital signal using one of a memoryless predistortion function and a memory polynomial predistortion function to obtain the second digital signal; and said introducing the analog predistortion into the second analog signal comprises: introducing analog predistortion into the second analog signal using the other one of the memoryless predistortion function and the memory polynomial predistortion function to obtain the third analog signal.

In some embodiments, the second method further comprises: downconverting the fourth analog signal to a frequency lower than the radio frequency to obtain a fifth analog signal; obtaining a fourth digital signal from the fifth analog signal, the fourth digital signal having a sampling rate lower than a full sampling rate for the fifth analog signal; estimating power-amplifier distortion based on the fourth digital signal and the second digital signal; and using the estimated power-amplifier distortion to train the memoryless predistortion function, the memory polynomial predistortion function, or both the memoryless predistortion function and the memory polynomial predistortion function.

In some embodiments, a ratio D₃ of the full sampling rate over the sampling rate of the fourth digital signal is greater than one.

In some embodiments, a ratio D₃ of the full sampling rate over the sampling rate of the fourth digital signal is 100.

In some embodiments, the fourth digital signal has a resolution of 3 bits or 4 bits.

According to one aspect of this disclosure, there is provided a third method for estimating distortion coefficients of a power amplifier (PA) for compensating distortion of the PA, the third method comprising: oversampling an input digital signal by a first oversampling factor D₁ to obtain a first digital signal; oversampling the first digital signal by a second oversampling factor D₂ to obtain a second digital signal; obtaining a first analog signal from the second digital signal; upconverting the first analog signal to a radio frequency to obtain a second analog signal; amplifying the second analog signal using a power amplifier to obtain a third analog signal; downconverting the third analog signal to a frequency lower than the radio frequency to obtain a fourth analog signal; obtaining a third digital signal from the fourth analog signal, the third digital signal having a sampling rate lower than a full sampling rate for the fourth analog signal; estimating power-amplifier distortion based on the third digital signal and the first digital signal; and using the estimated power-amplifier distortion to train the memoryless predistortion function, the memory polynomial predistortion function, or both the memoryless predistortion function and the memory polynomial predistortion function.

In some embodiments, D₁ is less than 5.

In some embodiments, D₁ is 2, 3, or 4.

In some embodiments, a multiplication of D₁, D₂, and a sampling rate of the input signal is greater than or equal to the full sampling rate.

In some embodiments, a ratio D₃ of the full sampling rate over the sampling rate of the third digital signal is greater than one.

In some embodiments, a ratio D₃ of the full sampling rate over the sampling rate of the third digital signal is 100.

In some embodiments, the third digital signal has a resolution of 3 bits or 4 bits.

According to one aspect of this disclosure, there is provided a circuitry for performing the above-described first, second, and/or third method.

According to one aspect of this disclosure, there is provided one or more non-transitory computer-readable storage media comprising computer-executable instructions, wherein the instructions, when executed, cause one or more processors to perform the above-described first, second, and/or third method.

According to one aspect of this disclosure, there is provided an apparatus comprising: one or more non-transitory computer-readable storage media; and one or more processors functionally connected to the one or more non-transitory computer-readable storage media for performing the above-described first, second, and/or third method.

According to one aspect of this disclosure, there is provided a module for performing the above-described first, second, and/or third method.

In some embodiments, the module comprises: one or more non-transitory computer-readable storage media; and one or more processors functionally connected to the one or more non-transitory computer-readable storage media for performing the above-described first, second, and/or third method.

In some embodiments, the module comprises: a downconverter for performing said downconverting the radio-frequency analog signal; an analog-to-digital converter for performing said converting the first analog signal to the second digital signal; a power-amplifier distortion estimator for performing: said estimating the power-amplifier distortion coefficients, said calculating the estimation error of the estimated power-amplifier distortion coefficients, said determining that the estimation error is larger than the estimation error threshold, and said repeating said estimating the power-amplifier distortion coefficients step.

The technical features and benefits of the methods, modules, apparatuses, systems, and one or more non-transitory computer-readable storage media disclosed herein may include:
Adaptive power-amplifier distortion estimation using pseudo-preamble with varying lengths, which mitigates the impact of low resolution and low feedback-loop sampling rate and providing sufficient power-amplifier estimation accuracy and linearization performance, and which significantly reduces hardware cost by reducing the feedback-loop sampling rate up to 100 times and analog-to-digital-converter resolution bits to 3 to 4 bits.
Hardware complexity control through segmented power-amplifier estimation augmented with asynchronous accumulation and averaging design, which would not increase hardware complexity when a longer pseudo-preamble is used.
New integrated multi-rate and hybrid predistortion adopting PA-distortion-characteristics-specified multi-rate assignment, which tailors different and specific sampling rates to the decomposition and elimination of power-amplifier static and dynamic distortions respectively, thereby mitigating the impact of the low baseband sampling rate and providing sufficient linearization performance.
Memoryless digital predistortion with adaptive sampling rate, which achieves further reduced hardware cost by alleviating baseband sampling rate requirement from conventionally at least five (5) times of the original sampling rate to three (3) times of the original sampling rate.
Memory polynomial analog predistortion with adaptive sampling rate, which improves linearization performance.

With the increase of frequency bands in wireless communications such as sixth-generation (6G) mobile communications, the implementation cost of predistortion becomes unaffordable due to the exacerbated nonlinearities of power amplifiers in wireless-communication devices. The predistortion method disclosed herein achieves cost-effective power-amplifier linearization with significantly reduced resolution and sampling rates, making it a promising solution for wireless communication systems such as 6G systems.

### BRIEF DESCRIPTION OF THE DRAWINGS

For a more complete understanding of the disclosure, reference is made to the following description and accompanying drawings, in which:

FIG. 1 is a schematic diagram showing a general signal-amplification structure for amplifying and transmitting a radio-frequency (RF) signal;

FIG. 2 is a schematic diagram showing a transceiver system using a hybrid predistortion method for power-amplifier (PA) linearization;

FIG. 3 is a schematic diagram showing a transceiver system using a hybrid predistortion method for PA linearization, according to some embodiments of this disclosure;

FIG. 4 is a flowchart showing a procedure performed by the transceiver system shown in FIG. 3 for PA linearization, according to some embodiments of this disclosure;

FIG. 5 is a schematic diagram showing the predistortion system shown in FIG. 3 in a PA distortion estimation stage;

FIG. 6 is a flowchart showing the details of an adaptive PA distortion estimation method performed by an adaptive PA distortion estimator of the predistortion system shown in FIG. 3 the PA distortion estimation stage shown in FIG. 5, according to some embodiments of this disclosure;

FIG. 7 is a schematic diagram showing the predistortion system shown in FIG. 3 in a multi-rate hybrid predistortion stage;

FIG. 8 is a flowchart showing the steps performed by the transceiver system shown in FIG. 3 for training a memoryless predistortion module thereof and transmitting a predistorted information signal, according to some embodiments of this disclosure; and

FIG. 9 is a schematic diagram showing a transceiver system using a hybrid predistortion method for PA linearization, according to some embodiments of this disclosure.

### DETAILED DESCRIPTION

### A. Multi-Rate Hybrid Predistortion System and Method for Power-Amplifier Linearization

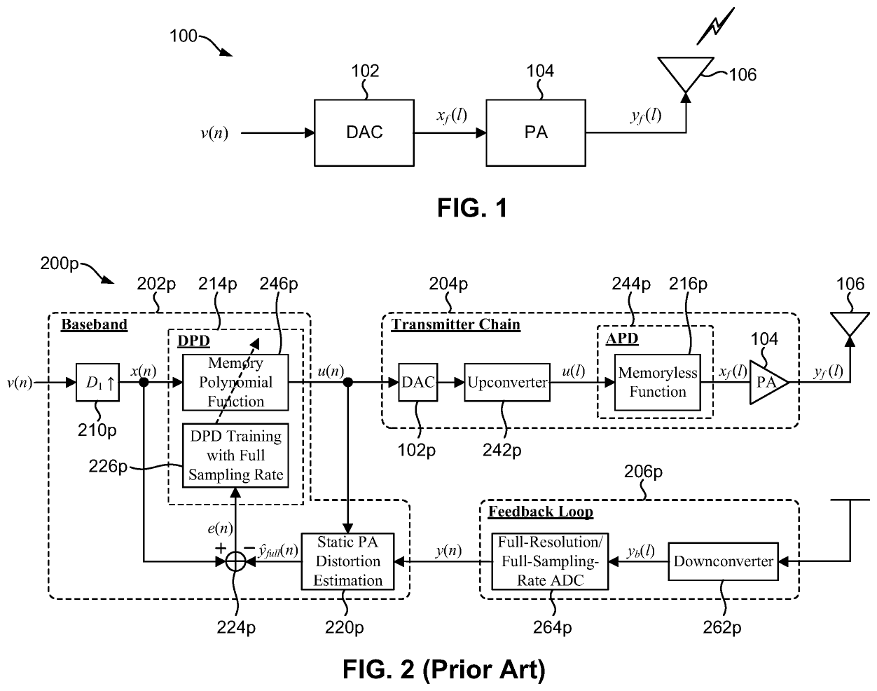

FIG. 1 is a schematic diagram showing a general signal-amplification structure 100 for amplifying and transmitting a radio-frequency (RF) signal. As shown, a digital signal v(n) (which may be, for example, a data frame modulated to the carrier frequency in the discrete time domain) is first converted to an analog signal x_{f}(l) by a digital-to-analog converter (DAC) 102. The analog signal x_{f}(l) is then amplified by a power amplifier (PA) 104 to obtain an amplified RF signal y_{f}(l), which is transmitted via an antenna 106.

The PA 104 often introduces distortions into the amplified signal y_{f}(l) due to its amplification nonlinearity and variation in its frequency response. Generally, a PA behavior model includes memoryless nonlinear distortion and memory nonlinear distortion. The memoryless nonlinear distortion refers to the distortion that is only related to the instant value of the input signal x_{f}(l). The memory nonlinear distortion refers to the distortion that is related to the instant value and past values of the input signal x_{f}(l), and may be modeled as a memory polynomial model.

FIG. 2 is a schematic diagram showing a conventional transceiver system 200p (where the suffix “p” refers to “prior-art”) using a hybrid predistortion method for PA linearization. The conventional transceiver system 200p comprises a plurality of modules including a baseband module 202p, a transmitter (Tx) chain 204p, and a feedback loop 206p. As the following description focuses on PA linearization using signal predistortion, the conventional transceiver system 200p is also denoted as a conventional “predistortion system”.

The baseband module 202p uses an oversampling unit 210p (also called an “upsampling unit”) to oversample the input baseband digital signal v(n) with an oversampling factor Dip. As those skilled in the art appreciate, generally, to guarantee satisfactory PA linearization performance, every module of the conventional predistortion system 200p (when ignoring the memoryless APD 244p) should run at the same sampling and the same processing rate which often employs five (5) times of the original input signal bandwidth by setting the upsampling factor D₁ₚ=5 in baseband.

After oversampling, the baseband module 202p introduces digital predistortion (DPD) to the oversampled digital signal x(n) to obtain a predistorted digital signal u(n), using a DPD module 214p comprising a memory polynomial predistortion module 246p having a memory polynomial function trained by a DPD training unit 226p.

The Tx chain 204p uses a DAC 102p to convert the predistorted digital signal u(n) to an analog signal, which is upconverted to the carrier frequency by an upconverter 242p to obtain a RF signal u(l). Then, the Tx chain 204p introduces analog predistortion (APD) to the RF signal u(l) to obtain a further predistorted RF signal x_{f}(l), using an APD module 244p having a memoryless function 216p. The further predistorted RF signal x_{f}(l) (which has both DPD and APD) is amplified by a PA 104. The amplified RF signal y_{f}(l) is transmitted via an antenna 106.

The feedback loop 206p obtains a copy of the amplified RF signal y_{f}(l), and uses a downconverter 262p to downconvert the obtained high-frequency RF signal y_{f} (l) to a lower-frequency analog signal y_{b}(l) (such as a baseband analog signal), which is then converted to a digital signal y(n) using a full-resolution, full-sampling-rate analog-to-digital converter (ADC) 264p. The obtained digital signal y(n) is then fed back to a static PA distortion estimator 220p of the baseband module 202p to obtain an estimated signal ŷ_{full}(n), which is compared (224p) with the oversampled digital signal x(n) to obtain an error signal e(n). A DPD training unit 226p operating at the full sampling rate uses the error signal e(n) to train the memory polynomial function 246p. Herein, the term “full sampling rate” (denoted “R_{full}”) refers to the Nyquist rate of the analog RF signal y_{b}(l) which may comprise PA distortion. Note that, according to the Nyquist's theorem, a signal must be sampled at more than twice of the bandwidth of the signal to avoid aliasing. Therefore, due to the large bandwidth of the PA distortion in the analog signal y_{b}(l), the full sampling rate is generally much higher than the sampling rate of the non-distorted analog signal y_{b}(l) if the PA has an ideal response. Such a full sampling rate may be at least five (5) times of the bandwidth of the input signal v(n) to accurately capture the distortion that may be introduced by the PA 104. Even if the PA distortion may be compensated for, the conventional technologies (such as the technology shown in FIG. 2) still needs the full sampling rate to accurately estimate the PA distortion and evaluate the predistortion coefficients of the memory polynomial function 246p and memoryless function 216p.

In the following, the exemplary “at least five (5) times of the bandwidth of the input signal v(n)” is used to represent the full sampling rate.

In the conventional predistortion system 200p, the hybrid predistortion method aims at lowering the sampling rate in the Tx chain 204p that emerged from the hybridization of DPD and APD with stringent real-time constraints, thus partially reducing implementation cost. The hybrid predistortion method combines memory polynomial predistortion 246p in the digital domain with memoryless predistortion 216p in the RF analog domain, resulting in a partially predistorted signal, with a reduced sampling rate in the Tx chain 204p, compared to the fully predistorted signal.

However, the conventional predistortion system 200p shown in FIG. 2 still suffers from high implementation cost, for example, in the following aspects:
The static PA distortion estimator 220p relies on real-time estimation of PA distortion behaviors for accurate predistortion, which may require high-cost real-time signal processing of the full-resolution and full-sampling-rate signal y(n).
The output RF signal yr (l) of the PA 104 is downconverted and digitized (by the full-resolution, full-sampling-rate ADC 264p) for properly estimating PA distortions. To reduce quantization error, high number of quantization bits (that is, high bit-resolution; typically 8 bits to 14 bits) in the full-resolution, full-sampling-rate ADC 264p is needed.
As successful PA linearization hinges on a high sampling and processing rate (that is, at least five (5) times of original sampling rate; for example, at gigasamples-per-second (Gsps) level), at least two modules of the conventional predistortion system 200p, including the baseband module 202p and feedback loop 206p, require the high sampling and processing rate.

Therefore, it is desirable to provide a PA linearization method, such as a signal predistortion method for PA linearization, with significantly reduced implementation cost, which may be particularly useful for future wireless communications such as 6G mobile systems. Specifically, it is desirable that the PA linearization method may:
Alleviate real-time constraints while controlling hardware complexity in PA distortion estimation; and/or
Guarantee PA estimation accuracy and linearization performance under low resolution of ADC as well as low sampling rate in baseband and the feedback loop.

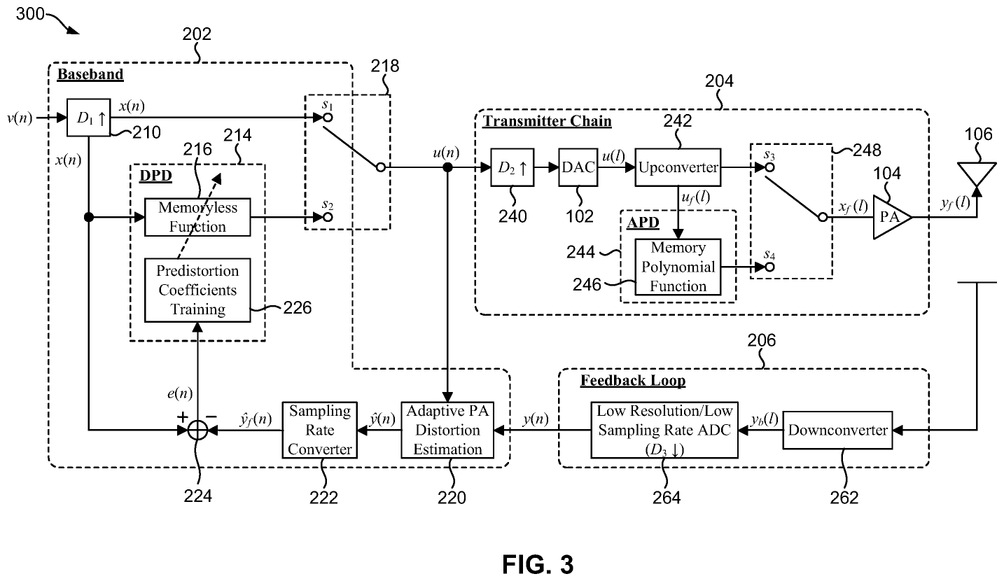

FIG. 3 is a schematic diagram of an example of a 6G transceiver system 300 using a hybrid predistortion method for PA linearization, according to some embodiments of this disclosure. As the following description focuses on PA linearization using signal predistortion, the 6G transceiver system 300 is also denoted a 6G “predistortion system”.

The structure of the 6G predistortion system 300 is similar to the conventional predistortion system 200p shown in FIG. 2. Accordingly, the blocks shown in FIG. 3 that are similar to those shown in FIG. 2 are identified using same reference numerals (without the suffix “p”), which, however, do not mean that the blocks in FIGS. 2 and 3 having the same reference numeral are necessarily the same. In other words, the blocks in FIGS. 2 and 3 having the same reference numeral may be used in respective systems for similar purposes (and not necessarily the same purposes), while other aspects thereof, such as their functions, structures, implementations, and/or the like, may not necessarily be the same.

As shown in FIG. 3, the predistortion system 300 comprises a plurality of modules including a baseband module 202 for receiving an input digital signal v(n) and introducing DPD thereto, a Tx chain 204 for converting the input digital signal v(n) to an analog RF signal, introducing APD thereto, and amplifying the analog RF signal for transmission, and a feedback loop 206 for facilitating the signal predistortion. Unless otherwise explicitly specified, the digital signals in FIG. 3 are at sampling rates lower than the full sampling rate. Accordingly, the modules, blocks, or components in the feedback loop 206 of FIG. 3 operate at sampling rates lower than the full sampling rate, unless otherwise explicitly specified.

The baseband module 202 comprises an oversampling unit 210 (also called a “upsampler”) having an oversampling factor D₁ (which is smaller than five (5) in these embodiments), a DPD module 214, an adaptive PA distortion estimator 220, and a sampling rate converter 222.

The oversampling unit 210 is for increasing the sampling rate of the input digital signal v(n) by an oversampling factor D₁ to obtain an oversampled digital signal x(n). In other words, the sampling rate Rₓ of the oversampled digital signal x(n) is Rₓ=D₁Rᵥ, where Rᵥ is the sampling rate of the input signal v(n). As those skilled in the art will appreciate, a higher sampling rate allows for more accurate linearization. However, as D₁ is smaller than five (5), Rₓ is lower than the full sampling rate R_{full}.

In these embodiments, each of the oversampling units 210 and 240 generally comprises a function or circuit for periodically inserting samples (such as samples of value zero (0)) into the input signal, followed by a function or circuit of a finite impulse response (FIR) filter to limit the bandwidth of the oversampled signal to the same bandwidth of the input signal. Similarly, the ADC 264 (or effectively its downsampling function (having a downsampling factor D₃)) generally comprises a function or circuit for downsampling the input signal followed by a function or circuit of a FIR filter to limit the bandwidth of the oversampled signal to the same bandwidth of the input signal.

For example, in some embodiments where D₁ is an integer (such as three (3)), the oversampling unit 210 comprises a function or circuit for inserting D₁-1 zeros (0's) between each neighboring samples of the input signal, followed by a FIR filter to limit the bandwidth of the oversampled signal to the same bandwidth of the input signal.

As another example, in some embodiments where D₁ is a fraction number (such as 2.5), the oversampling unit 210 first inserts D₁ₐ−1 zeros (0's) between each neighboring samples of the input signal, then filters the upsampled signal by a FIR filter to limit the bandwidth of the oversampled signal to the same bandwidth of the input signal, then downsamples the filtered signal by D_{1b}, and filters the downsampled signal by the FIR filter to limit the bandwidth of the oversampled signal to the same bandwidth of the input signal, wherein D₁ₐ/D_{1b}=D₁.

The DPD module 214 comprises a memoryless predistortion module 216 and a predistortion coefficients training unit 226. The memoryless predistortion module 216 uses a memoryless predistortion function for introducing memoryless predistortion into the oversampled digital signal x(n). In other words, the memoryless predistortion module 216 applies compensation to the output RF signal y_{f} (l) of the PA 104 based solely on its static distortion characteristics. For example, the academic paper entitled “A digital predistortion system with extended correction bandwidth with application to LTE-A nonlinear power amplifiers,” to Hammi, et al., published in IEEE Transactions on Circuits and Systems—I: Regular Papers, 61(12), 3487-3495, describes a mathematical model of a memory polynomial function as:

$${x}_{interm} ( i ) = {\sum }_{n = 0}^{N} {\sum }_{m = 0}^{M} {a}_{{nm}^{x} in} ( i - m ) {\vert {x}_{i n} ( i - m ) \vert}^{n} , \qquad ( 1 )$$

where xᵢₙ(i) and xᵢₙₜₑᵣₘ(i) are the input and output of the memory polynomial function, respectively, M and N are the memory depth and the nonlinearity order, respectively, and aₙₘ are the PA distortion coefficients. The memory polynomial function becomes a memoryless predistortion function when M=0.

As those skilled in the art will appreciate, the memory polynomial function and memoryless predistortion function characterize the PA 104. Accordingly, the memoryless predistortion module 216 and the memory polynomial predistortion module 246 may leverage these functions to compensate for the PA distortion.

In these embodiments, the memoryless predistortion module 216 and the memory polynomial predistortion module 246 use the same function with different memory depth orders (that is, a zero memory-depth for the memoryless predistortion module 216 and a nonzero memory depth for the memory polynomial predistortion module 246) with the same set of predistortion coefficients (also denoted “predistorter coefficients”). Of course, those skilled in the art will appreciate that, in other embodiments, other memory polynomial function and memoryless predistortion function may be used, wherein the memory polynomial function and memoryless predistortion function may or may not be the same function, and the predistortion coefficients thereof may or may not be the same set of coefficients. Generally, it is preferable to train the predistortion coefficients of both the memory polynomial function and memoryless predistortion function, although in some embodiments, the predistortion coefficients of one of the memory polynomial function and memoryless predistortion function may be trained and the predistortion coefficients of the other one of the two functions may be a set of predefined or predetermined coefficients.

The predistortion coefficients training unit 226 operates at the same sampling rate as x(n) and uses Equation (1) for training the predistortion coefficients of the memoryless predistortion function of the memoryless predistortion module 216 (which is equivalent to training for determining aₙₘ in above Equation (1)).

The adaptive PA distortion estimator 220 is for estimating the distortion introduced by the PA 104. More specifically, the adaptive PA distortion estimator 220 receives the signal u(n) outputted from the baseband module 202 and the signal y(n) outputted from the feedback loop 206, adjusts them to the same sampling rate (for example, downsampling the signal u(n) to the same sampling rate as the signal y(n)), and compares them to observe characteristics of the transmitted signal y_{f} (l) and detects nonlinear distortions asynchronously by using pseudo-preambles (described in more detail later) with varying lengths to mitigate the impact of the low resolution and low sampling rate of the feedback loop 206. The adaptive PA distortion estimator 220 outputs an estimated signal ŷ (n).

The sampling rate converter 222 is used to convert the lower-sampling-rate y(n) to a higher-sampling-rate signal ŷ_{f} (n) so as to meet the equivalency requirement in sampling rates between the oversampled digital signal x(n) and the estimated PA-output signal ŷ (n) (outputted from the feedback loop 206) during the training of predistortion (that is, the higher-sampling-rate signal ŷ_{f}(n) (converted from the estimated PA-output signal ŷ(n)) has the same sampling rate as the oversampled digital signal x(n)).

The Tx chain 204 is for converting the output of the baseband module 202 into an analog format suitable for transmission via the antenna 106. The Tx chain 204 comprises an oversampling unit 240 having an oversampling factor D₂, a DAC 102, an upconverter 242 (also called an “upconversion mixer”), a APD module 244 having a memory polynomial predistortion module 246, and a PA 104.

The oversampling unit 240 is for increasing the sampling rate of the digital signal u(n) output from the baseband module 202 (by the oversampling factor D₂) to meet the high sampling rate requirement in implementing memory polynomial APD. For example, in some embodiments, D₂ may be a value such that, after oversampling, the sampling rate is greater than or equal to full sampling rate, that is, D₁ D₂Rᵥ≥R_{f}. In various embodiments, the oversampling unit 240 may be integrated with the DAC 102 or may be physically separated from and functionally connect to the DAC 102.

The DAC 102 converts the oversampled digital signal outputted from the oversampling unit 240 into an analog signal u(l).

The upconverter 242 upconverts the analog signal u(l) to the desired carrier frequency (that is, shifting the signal frequencies of the analog signal u(l) to frequencies around the carrier frequency) for use by the APD module 244 or for amplification by the PA 104.

The APD module 244 or more specifically the memory polynomial predistortion module 246 thereof comprises a memory polynomial predistortion function to compensate for memory-dependent nonlinear distortions of the PA 104.

In some embodiments, the memory polynomial function of the memory polynomial predistortion module 246 may be changed with different memory depths and order. Accordingly, the required sampling rate of its input signal y_{f}(l) (which is the output signal of the upconverter 242) may also be adaptively changed. Thus, in these embodiments, the value of the oversampling factor D₂ of the oversampling unit 240 is not fixed and may be changed adaptively based on the linearization performance requirement.

The PA 104 is a component in the Tx chain 204 for amplifying the RF signal x_{f} (l) (outputted from the upconverter 242 or the APD module 244) to a level suitable for transmission via the antenna 106. The predistortion is applied to mitigate the nonlinearities induced by the PA 104 and ensure that the PA-output signal yr (l) is linearized and meets relevant quality standards for transmission. Herein, the output of the DAC 102, the output of the upconverter 242, and the output of the PA 104 are indeed continuous-time analog signals. However, in the following, these signals are described as high-resolution digital signals u(l), u_{f} (l), x_{f}(l), and y_{f} (l) sampled at the full sampling rate.

The feedback loop 206 obtains a copy of the PA-output signal y_{f} (l) and outputs a digital signal y(n) for estimating the PA distortion. The feedback loop 206 comprises a downconverter 262 (also called a “downconversion mixer”) and an ADC 264 with a low resolution and a low sampling rate.

The downconverter 262 converts the obtained high-frequency PA-output signal y_{f}(l) to a low-frequency analog signal y_{b}(l) such as a baseband analog signal.

The ADC 264 converts the analog signal y_{b}(l) to a digital signal y_{b}(n). The ADC 264 has a low resolution and a low sampling rate. For example, in some embodiments, the ADC 264 may have a resolution of lower than eight (8) bits (compared to ADCs that usually have resolutions of 8-14 bits), and a sampling rate of R_{y}=R_{full}/D₃ (represented as D_{3↓} in FIG. 3; that is, effectively equivalent to having a built-in downsampling unit that downsamples from the full sampling rate R_{full} by a downsampling factor of D₃ (for example, D₃=100)). Such a low-resolution and low-sampling-rate ADC 264 has a reduced circuitry complexity. Thus, the implementation cost thereof is reduced (in terms of both materials and manufacturing).

With the use of the oversampling units 210 and 240, and the downsampling effect of the ADC 264, the predistortion system 300 is generally a multi-rate system where different modules thereof may run at different sampling and processing rates. Accordingly, the requirement of baseband sampling and processing rate is alleviated by using an upsampler 210 with a small upsampling factor D₁ (smaller than, for example, five (5)) in the baseband module 202, without compromising the linearization performance because of the use of another upsampler 240 with an upsampling factor D₂ in the Tx chain 204. Moreover, the sampling rate in the feedback loop 206 is significantly reduced by employing the low-resolution and low-sampling-rate ADC 264 with an effective downsampling factor D₃.

In these embodiments, the predistortion system 300 estimates the PA distortion using pseudo-preambles, and introduces predistortion to the input signal (or equivalently the analog PA-input signal x_{f}(l)) based on the estimated PA distortion).

To concurrently capture the static and dynamic aspects of the nonlinear distortion arising from PA circuits driven by much wider signal bandwidth in 6G, the PA behavioral model employs a combination of static nonlinear distortion function and dynamic nonlinear distortion function, thereby facilitating precise distortion estimation.

Specifically, the static nonlinear distortions are formulated as a memoryless polynomial function (used in the memoryless predistortion module 216) and the dynamic nonlinear distortions are modeled by a memory polynomial function (used in the memory polynomial predistortion module 246) with dynamic memory depth and polynomial order. Therefore, based on the PA input signal x_{f}(l) with full sampling rate at time instant l, the PA output signal y_{f} (l) with full sampling rate is formulated as:

$${y}_{f} ( l ) = {\sum }_{p = 0}^{P - 1} {\sum }_{m = 0}^{M - 1} {a}_{p , {m}^{x} f} ( l - m ) {\vert {x}_{f} ( l - m ) \vert}^{p} , \qquad ( 2 )$$

where the estimated coefficients of intrinsic PA distortion characteristics can be represented as a matrix a_{p,m} with p-th polynomial order and m-th memory depth. Especially, m=0 for static distortion and m>0 for dynamic distortion. Besides, larger M and P indicate higher memory depth and nonlinearity order.

As x_{f}(l) and y_{f} (l) both satisfy x_{f} (nD₂)=x_{f}(l) and y_{f} (nD₃)=y_{f} (l), Equation (2) can be rewritten as:

$${y}_{f} ( {nD}_{3} ) = {\sum }_{p = 0}^{P - 1} {\sum }_{m = 0}^{M - 1} {a}_{p , {m}^{x} f} ( {nD}_{2} - m ) {\vert {x}_{f} ( {nD}_{2} - m ) \vert}^{p} . \qquad ( 3 )$$

The accuracy of PA distortion estimation is significantly decreased with reduced feedback-loop sampling rate (that is, the sampling rate of the signal y(n) outputted from the feedback loop 206, the sampling rate of which is a reduced sampling rate because of the low sampling rate of the ADC 264) and the low resolution of the ADC 264. The slow-varying distortion characteristics of the PA 104 allow for longer observation and selection of longer PA estimation pseudo-preambles (that is, the local PA input and output signals). Herein, the pseudo-preambles include the PA-input pseudo-preamble and the PA-output pseudo-preamble. The PA-input pseudo-preamble refers to a signal for inputting to the PA 104, and the PA-output pseudo-preamble is the PA output signal y_{f} (l) in accordance with the specific PA input signal x_{f}(l).

Therefore, in these embodiments, an adaptive PA distortion estimation method using pseudo-preambles with varying lengths is used for estimating PA distortion with increased estimation accuracy under lowered feedback-loop sampling rate and lowered ADC resolution, leading to a more efficient and cost-effective predistortion system 300 for 6G wireless communications.

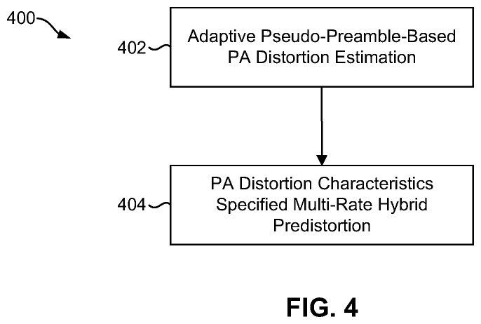

FIG. 4 is a flowchart showing a procedure 400 performed by the predistortion system 300, according to some embodiments of this disclosure. As shown, the predistortion system 300 in these embodiments operates in two stages, including a PA distortion estimation stage 402 for adaptively estimating PA distortion using pseudo preambles, and a multi-rate hybrid predistortion stage 404 for signal predistortion based on the PA distortion characteristics determined in stage 402. The two stages are represented in FIG. 3 using the two switches 218 and 248.

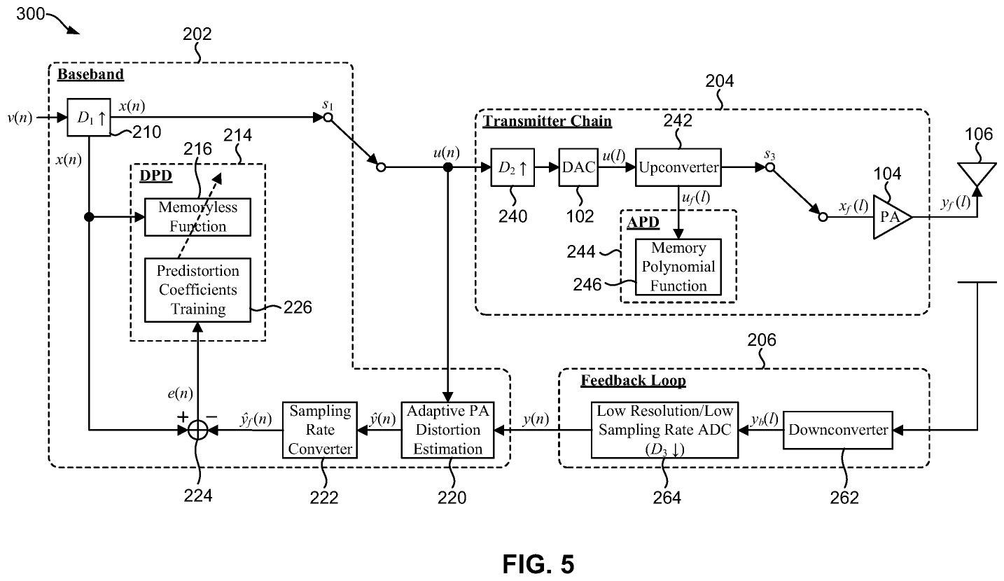

Illustratively, the predistortion system 300 operates in the PA distortion estimation stage 402 when the two switches 218 and 248 are switched to the up positions, that is, switch 218 switches to s₁, and switch 248 switches to s₂. FIG. 5 shows the predistortion system 300 in the PA distortion estimation stage 402. In FIG. 5, the two switches 218 and 248 are removed, indicating that, in various embodiments, the two switches 218 and 248 may not be necessary components of the preditortion system 300, and the two stages 402 and 404 may be implemented in any suitable way.

At the PA distortion estimation stage 402, the signal v(n) is a known signal used for estimating the PA distortion (which may be a signal similar to or the same as the actual signals (such as OFDM signals) to be transmitted following the signal v(n). The oversampling unit 210 oversamples the signal v(n) by the oversampling factor D₁ and outputs an oversampled signal x(n). At this stage, the output signal u(n) of the baseband module 202 is the oversampled signal x(n), that is, u(n)=x(n). In the Tx chain 204, the oversampling unit 240 further oversamples the oversampled signal x(n) by the oversampling factor D₂. The further oversampled signal is converted to an analog signal by the DAC 102 to obtain an analog signal u(l), which is upconverted to the carrier frequency by the upconverter 242 to obtain the PA-input RF signal or the PA-input pseudo-preamble x_{f} (I). The PA 104 amplifies the PA-input pseudo-preamble x_{f}(l) and outputs a PA-output RF signal or PA-output pseudo-preamble y_{f} (l).

The PA-output pseudo-preamble y_{f} (l) is sent to the feedback loop 206, wherein the PA-output pseudo-preamble y_{f}(l) is downconverted to the baseband or IF by the downconverter 262 to obtain the analog signal y_{b}(l), which is converted to a digital signal y(n) by the low-resolution and low-sampling-rate ADC 264, which is sent to the adaptive PA distortion estimator 220. The digital signal y(n) is effectively downsampled from the full sampling rate by a downsampling factor D₃.

In these embodiments, the adaptive PA distortion estimator 220 receives the output signal u(n) of the baseband module 202 (which is the oversampled signal x(n)) and the downsampled digital PA-output signal y(n), adjusts the signals u(n) and y(n) to the same sampling rate (for example, downsampling the signal u(n) to the same sampling rate as the signal y(n)), and uses a low-resolution and low-sampling-rate adaptive PA-distortion estimation method for estimating the PA distortion. While the adaptive distortion estimation method operates in a low resolution (such as lower than eight (8) bits) and a low sampling rate (D₃>1), the adaptive PA distortion estimation method may obtain PA distortion estimation with reduced estimation error that may be otherwise caused by the downsampling in the feedback loop 206 and the low resolution of the ADC 264 of the feedback loop 206.

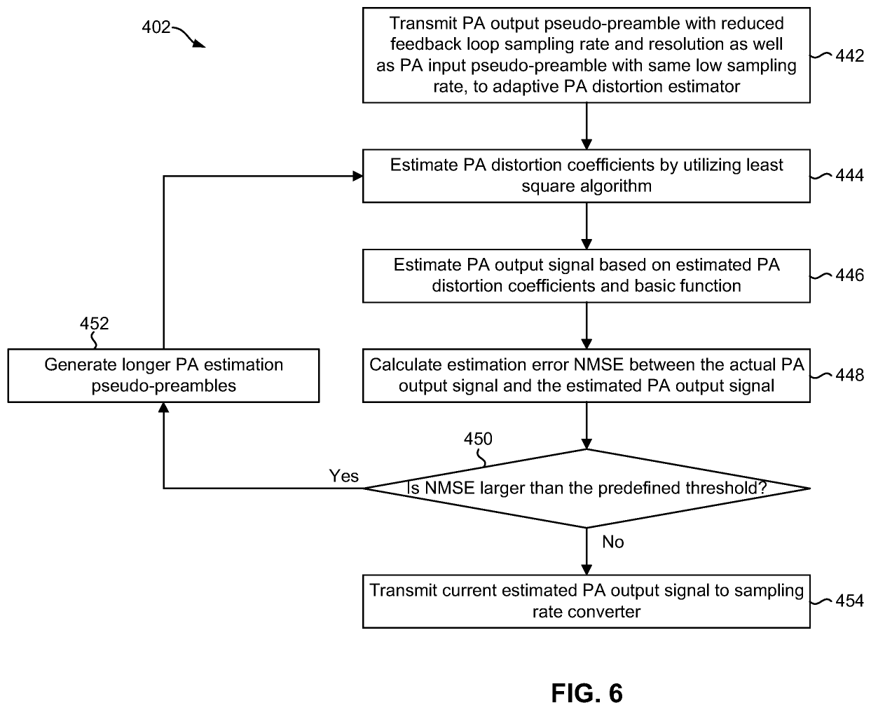

FIG. 6 is a flowchart showing the details of the adaptive PA distortion estimation method (also identified as 402) performed by the adaptive PA distortion estimator 220 at stage 402. For ease of description, the oversampled signal x(n) is conveniently denoted the PA-input pseudo-preamble, and the downsampled digital PA-output signal y(n) is also conveniently denoted the PA-output pseudo-preamble.

At step 442 the PA-output pseudo-preamble y(n) (having a reduced feedback-loop sampling rate and a reduced resolution) and the PA input pseudo-preamble u(n) (which is the signal x(n) and having a low sampling rate) are transmitted to the adaptive PA distortion estimator 220. If needed (for example, when D₃≠1), the adaptive PA distortion estimator 220 adjusts the signals x(n) and y(n) to the same sampling rate (for example, downsampling the signal x(n) to the same sampling rate as the signal y(n)). Then, each of the PA-input and PA-output pseudo-preambles x(n) and y(n) contains N samples. For ease of description, in the following when x(n) and y(n) (or u(n) and y(n)) are used together, x(n) and y(n) refer to the sampling-rate-adjusted versions thereof.

Thus, as the signal is transmitted from feedback loop 206 to baseband 202, the PA output signal, that is, the PA-output pseudo-preamble, y(n) under the reduced sampling rate and the reduced bit-resolution can be expressed by:

$$\begin{matrix}y ( n ) = {\sum }_{p = 0}^{P - 1} {\sum }_{\frac{m}{{D}_{3}} = 0}^{( M - 1 ) / {D}_{3}} {a}_{p , \frac{m}{{D}_{3}}} x ( \frac{{D}_{2}}{{D}_{3}} n - \frac{m}{{D}_{3}} ) {\vert x ( \frac{{D}_{2}}{{D}_{3}} n - \frac{m}{{D}_{3}} ) \vert}^{p} \\ = {\sum }_{p = 0}^{P - 1} {\sum }_{q = 0}^{Q - 1} {g}_{p , q} x ( kn - q ) {\vert x ( kn - q ) \vert}^{p} ,\end{matrix} \qquad ( 4 )$$

where g_{p,q} is the estimated PA distortion coefficients with low sampling rate and resolution,

$$q = \frac{m}{{D}_{3}} , k = \frac{{D}_{2}}{{D}_{3}}$$

indicate the new memory depth and ratio between the DAC and ADC sampling rates, respectively.

Similarly, the matrix forms of the PA-input pseudo-preamble and PA-output pseudo-preamble within a finite time horizon N can be expressed as:

$$X = {[ x ( kn ) , x ( k ( n + 1 ) ) , … , x ( k ( n + N - 1 ) ) ]}^{T} \qquad ( 5 )$$

$$and$$

$$Y = {[ x ( kn ) , x ( k ( n + 1 ) ) , … , y ( k ( n + N - 1 ) ) ]}^{T} . \qquad ( 6 )$$

After collecting the total samples of the PA-input preamble and PA-output preamble within the finite time horizon N, Equation (4) can be represented as a matrix equation as follows:

$$Y = Ω G , \qquad ( 7 )$$

where G denotes the PA distortion coefficients with PQ×1 dimensions and Ω is the basic function matrix with N×PQ dimensions which is formulated as:

$$( 8 )$$

$$Ω = {[ \begin{matrix}{w}_{0 , 0} ( x ( kn ) ) & {w}_{1 , 1} ( x ( kn ) ) & … & {w}_{P - 1 , Q - 1} ( x ( kn ) ) \\ {w}_{0 , 0} ( x ( k ( n + 1 ) ) ) & {w}_{1 , 1} ( x ( k ( n + 1 ) ) ) & … & {w}_{P - 1 , Q - 1} ( x ( k ( n + 1 ) ) ) \\ ⋮ & ⋮ & ⋱ & ⋮ \\ \begin{matrix}{w}_{0 , 0} ( x ( k ( n + \\ N - 1 ) ) )\end{matrix} & \begin{matrix}{w}_{1 , 1} ( x ( k ( n + \\ N - 1 ) ) )\end{matrix} & … & \begin{matrix}{w}_{P - 1 , Q - 1} ( x ( k ( n + \\ N - 1 ) ) )\end{matrix}\end{matrix} ]}_{N \times PQ}$$

where w_{p,q}(x(kn)) (0≤p≤P and 0≤q≤Q) indicates one of the interval samples of the PA input signal under p-th polynomial order and q-th memory depth. The basic function Ω comprises adjacent PA input samples

$$x ( \frac{{D}_{2}}{{D}_{3}} n )$$

obtained from x(n), which is the shifted signal x_{f}(l) to meet with y_{f} (nD₃)=y_{f}(l).

At step 444, the PA distortion coefficients Ĝ can be estimated under the low feedback-loop sampling rate and low ADC resolution by utilizing the least square method as follows:

$$\hat{G} = {( {Ω}^{H} Ω )}^{- 1} {Ω}^{H} Y . \qquad ( 9 )$$

At step 446, the PA output signal may be estimated based on the estimated PA distortion coefficients Ĝand basic function Ω as follows:

$$\hat{Y} = Ω \hat{G} . \qquad ( 10 )$$

where Ý is the vector of the estimated PA output signal ŷ (n).

In these embodiments, one sample of signal is collected at each time instant, the initial PA input and output signal x(n) and y(n) contains N samples within finite time horizon N indicating the initial pseudo-preamble length. Then at step 448, the estimation error between the actual PA output signal y(n) and the estimated PA output signal ŷ(n) is evaluated by employing the normalized mean square error (NMSE) metric as follows:

$$NMSE = 10 {log}_{10} ( \frac{{\sum }_{n = 1}^{N} {‖ y ( n ) - \hat{y} ( n ) ‖}^{2}}{{‖ y ( n ) ‖}^{2}} ) . \qquad ( 11 )$$

At step 450, the NMSE estimated at step 448 is compared with a predefined or predetermined PA-distortion estimation error threshold. If the NMSE is larger than the threshold, a PA-input pseudo-preamble having an increased length (such as the previously used PA-input pseudo-preamble (having N samples) combined with a new PA-input pseudo-preamble (having K samples; K may or may not be equal to N)) is generated (step 452), and the process loops to step 444 to re-estimate the PA distortion coefficients (see Equation (9)), PA output signal (see Equation (10)), and NMSE (see Equation (11)). Thus, the selection of PA estimation pseudo-preambles is adaptive rather than static.

If at step 450, it is determined that the NMSE is not larger than the threshold, the expected PA distortion estimation accuracy is achieved, and the adaptive PA distortion estimator 220 outputs the estimated PA-output signal ŷ(n) to the sampling rate converter 222. The sampling rate converter 222 converts the lower-sampling-rate signal ŷ(n) to a higher-sampling-rate signal ŷ_{f}(n) (the sampling rate of ŷ_{f} (n) is equal to that of x(n)), so as to meet the equivalency requirement in sampling rates between the oversampled digital signal x(n) and the estimated PA-output signal ŷ(n) during the training of predistortion. The predistortion system 300 then enters the PA-distortion-characteristics-specified multi-rate hybrid predistortion stage 404 and starts the process of linearizing the PA 104.

As can be seen, the adaptive PA distortion estimation method 402 uses the PA pseudo-preambles in an asynchronized and averaged way. For example, in time instant t, the PA input/output signals with 100 samples are used for PA distortion estimation (steps 444 to 448). However, the estimation accuracy is low. Then, in the next time instant t+1, the adaptive PA distortion estimation method 402 branches to step 452 to take another 100 samples of the same PA input/output signal to combine with the previous 100 samples, and then loops back to step 444 to re-estimate the PA distortion so as to mitigate the impact of low sampling rate and low resolution and to increase the accuracy of PA distortion estimation. Thus, the first 100 samples and the second 100 samples are processed asynchronously and the impacts of these samples to the accuracy of PA distortion estimation are effectively averaged. As a result, the accuracy of PA distortion estimation may be increased.

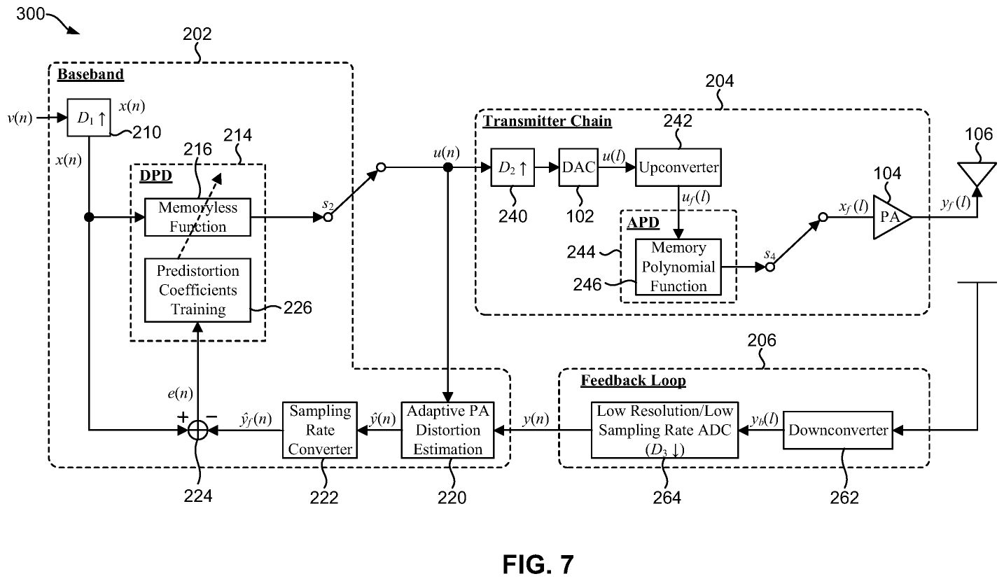

Illustratively, the predistortion system 300 operates in the multi-rate hybrid predistortion stage 404 when the two switches 218 and 248 are switched to the down positions, that is, switch 218 switches to s₂, and switch 248 switches to s₄. FIG. 7 shows the predistortion system 300 in the multi-rate hybrid predistortion stage 404 (the two switches 218 and 248 are removed), wherein the spectrum aliasing caused by reduced baseband sampling rate is removed by the memoryless DPD 214 for static distortion compensation. Additionally, the linearization performance is enhanced through the APD 244 for dynamic distortion compensation.

In these embodiments, the PA-distortion-characteristics-specified multi-rate hybrid predistortion 404 uses a reduced upsampling factor D₁ of the baseband oversampling unit 210 (compared to the upsampling factor D₁ of the baseband oversampling unit 210 in the prior-art predistortion system 200 shown in FIG. 2), which is tailored to the static type of nonlinear distortions exhibited by the ultra-broadband PA 104.

As the static distortion of PA 104 only necessitates narrow-band conditions for compensation, the baseband sampling and processing rate requirement can be reduced by only implementing a static DPD module 214 with a reduced upsampling factor D₁ to eliminate memoryless nonlinear distortions, thus achieving coarse linearization of the 6G PA 104. Furthermore, as dynamic predistortion needs a higher sampling rate with changing memory effects (compared to the sampling rate required by the static distortion of PA 104), by implementing dynamic predistortion in the analog domain using the APD module 244, the requirement of the sampling rate of the Tx chain 204 is partially satisfied by the baseband sampling rate to further increase the 6G PA linearization performance.

At the multi-rate hybrid predistortion stage 404, the higher-rate signal ŷ_{f}(n) is first used for training the memoryless polynomial function of the memoryless predistortion module 216. More specifically, the signal ŷ_{f}(n) is compared (224) with the oversampled digital signal x(n) to obtain an error signal e(n), which is sent to the predistortion coefficients training unit 226 for training the memoryless polynomial function of the memoryless predistortion module 216, such as optimizing or otherwise adjusting the predistortion coefficients of the memoryless polynomial function of the memoryless predistortion module 216 and the memory polynomial function of the memory polynomial predistortion module 246 based on the error signal e(n).

After the memoryless polynomial function of the memoryless predistortion module 216 is trained, an information signal (such as a signal having data or control information to be transmitted to a receiving device) is inputted to the transceiver system 300 (that is, the predistortion system) as the signal v(n). The transceiver system 300 introduces DPD and APD to the signal v(n) and obtains a predistorted PA-input RF signal x_{f} (l). The PA 104 amplifies the PA-input pseudo-preamble x_{f} (l) and outputs a PA-output RF signal y_{f} (l) for transmission via the antenna 106.

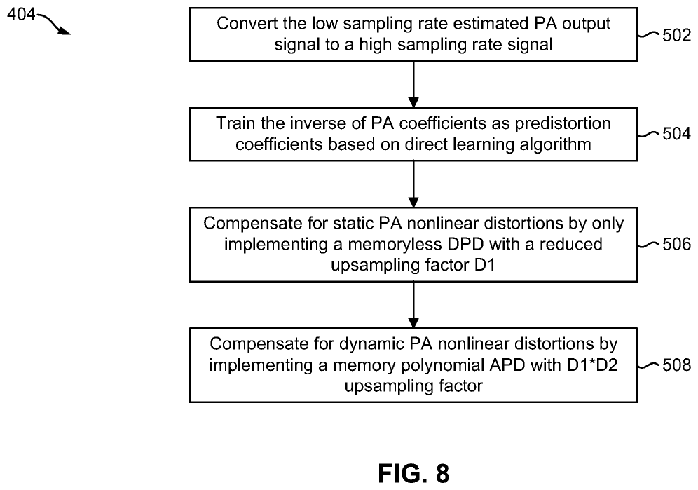

FIG. 8 is a flowchart showing the steps performed by the transceiver system 300 at the multi-rate hybrid predistortion stage 404 for training the predistortion coefficients and transmitting a predistorted information signal.

At step 502, given the equivalency requirement in sampling rates between the actual PA-input pseudo-preamble x(n) and estimated PA-output pseudo-preamble ŷ(n) (obtained in the PA distortion estimation stage 402), the low-rate y(n) is converted to a higher-rate signal ŷ_{f}(n) by the sampling rate converter 222. The matrix form of the estimated PA-output pseudo-preamble ŷ(n) with the same sampling rate as x(n) is formulated as:

$${\hat{Y}}_{f} = {[ {\hat{y}}_{f} ( kn ) , {\hat{y}}_{f} ( k ( n + 1 ) ) , … , {\hat{y}}_{f} ( k ( n + ( N + i τ ) - 1 ) ) ]}^{T} . \qquad ( 12 )$$

where PA estimation pseudo-preambles can be further collected within another finite time horizon T which discretizes into/time slots, each with the equal length τ, that is, T=Iτ, where i∈I and the pseudo-preamble length is extended to N+iτ within the i-th time slot.

As the predistortion-based PA linearization is to predistort the input signal applied to the PA 104, the predistortion coefficients training unit 226 in these embodiments uses a direct learning method to obtain predistortion coefficients through iterative training (step 504). More specifically, the predistorted signal u(n) is expressed in a matrix form as:

$$U = Ω Γ \qquad ( 13 )$$

where Γ=(γ_{0,0}, . . . , γ_{p,q}, . . . , γ_{P,Q})^{T} denotes the predistortion coefficients.

To estimate the predistortion coefficients, iterative training is used based on an error function as follows:

$$E = {\hat{Y}}_{f} - X = \tilde{E} + Θ , \qquad ( 14 )$$

where \tilde{E} indicates the error at time instant n−1, and Θ is the latest estimated error between x(kn) and ŷ_{f}(kn). Moreover, E, \tilde{E}, and Θ are all (N+iτ)-length column vectors of e(kn), \tilde{e}(kn), and θ(kn), respectively.

To minimize the error, a cost function C is defined by:

$$C = {‖ Θ ‖}^{2} = {‖ E - \tilde{E} ‖}^{2} = {\sum }_{n = 1}^{N + i τ} {\vert e ( kn ) - {\sum }_{p = 1}^{P} {\sum }_{q = 1}^{Q} Δ {γ}_{p , q} {w}_{p , q} ( x ( kn ) ) \vert}^{2} , \qquad ( 15 )$$

where Δγ_{p,q}=γ_{p,q}−γ_{p-1,q-1} indicates the predistortion-coefficient weight and is calculated by the least square algorithm as:

$$Δ {γ}_{p , q} = {( {Ω}^{H} Ω )}^{- 1} {Ω}^{H} ( {\hat{Y}}_{f} - X ) . \qquad ( 16 )$$

Then, the predistorter coefficients are estimated in the training block of DPD as follows:

$${γ}_{p , q} = {γ}_{p - 1 , q - 1} + η Δ {γ}_{p , q} , \qquad ( 17 )$$

where η indicates the iteration factor that satisfy 0<η<1. The trained predistorter coefficients γ_{p,q} may be used in the memoryless predistortion function and the memory polynomial predistortion function.

Based on the predistorter coefficients γ_{p,q}, a static DPD, or more specifically a memoryless predistortion function with a reduced upsampling factor D₁ is implemented in the memoryless predistortion module 216 for eliminating memoryless nonlinear distortions. Thus, the baseband sampling rate requirement is reduced with achievement of coarse linearization of the PA 104.

After the memoryless polynomial function of the memoryless predistortion module 216 is trained, an information signal is inputted to the transceiver system 300 as the signal v(n). The oversampling unit 210 oversamples the signal v(n) by the oversampling factor D₁ and outputs an oversampled signal x(n).

At step 506, the memoryless predistortion module 216 uses the trained memoryless predistortion function (with the D₁ upsampling factor) to introduce DPD into the oversampled signal x(n) and outputs the signal u(n). That is, the signal u(n) outputted from the baseband module 202 is the oversampled information signal with DPD.

In the Tx chain 204, the oversampling unit 240 further oversamples the signal u(n) by the oversampling factor D₂. The further oversampled signal is converted to an analog signal by the DAC 102 to obtain an analog signal u(l), which is upconverted to the carrier frequency by the upconverter 242 to obtain a RF signal u_{f} (I).

At step 508, the memory polynomial predistortion module 246 uses memory polynomial predistortion function with the trained predistorter coefficients γ_{p,g} (with an upsampling factor of D₁*D₂) to introduce APD to the RF signal u_{f} (I), and outputs the PA-input RF signal x_{f}(l).

The PA 104 amplifies the PA-input RF signal x_{f}(l) and outputs a PA-output RF signal y_{f}(l) for transmission via the antenna 106.

While not shown in FIG. 8, the feedback loop 206 is also in operating at the multi-rate hybrid predistortion stage 404 for further capturing PA distortion for linearization.

In some embodiments, the predistortion system 300 may use a suitable artificial intelligence method such as a suitable machine learning method for learn from changing estimation accuracy requirements and/or for training the predistortion coefficients.

In above embodiments, a transceiver system 300 (also called a predistortion system) is described as an example for illustrating the training and predistortion method. In some embodiments, the predistortion system 300 may be a transmitter system.

In some embodiments, the predistortion system 300 disclosed herein may be implemented as a device, a module, a component, or the like.

In some embodiments, the predistortion system 300 disclosed herein may be implemented purely as hardware (such as an integrated circuit (IC) chip or a portion thereof).

In some embodiments, the predistortion system 300 disclosed herein may be implemented as a mixture of hardware and software (such as an IC chip or a portion thereof that can execute computer-executable instructions stored in one or more non-transitory computer-readable storage devices (such as a memory) as software or firmware), and at least a portion of the training and predistortion method disclosed herein may be implemented as software or firmware with instructions stored in a memory and executable by one or more processors for collaborating with other hardware/software components, modules, devices, and/or systems to perform the training and predistortion method disclosed herein.

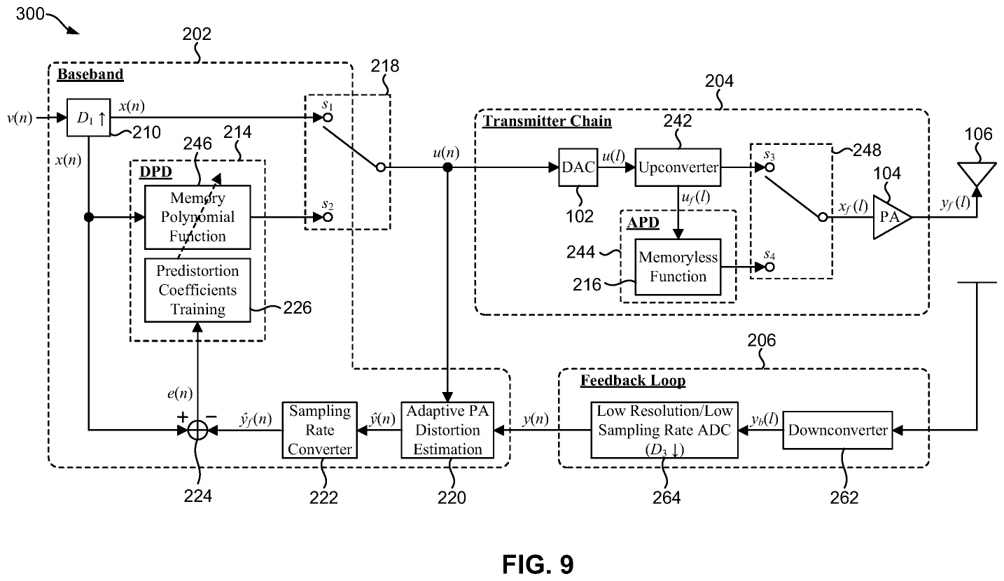

In some embodiments as shown in FIG. 9, the DPD module 214 may comprise a memory polynomial predistortion module 246 having a memory polynomial function in the baseband 202, and the APD module 244 may comprise a memoryless predistortion module 216 having a memoryless predistortion function in the Tx chain 204. The predistortion coefficients training unit 226 trains the predistortion coefficients of the memory polynomial function and/or the memoryless predistortion function.

In these embodiments, the feedback loop 206 may still run at a low sampling rate (that is, lower than the full sampling rate, or D₃>1). However, the baseband 202 may need a high sampling rate (for example, D₁=5) to avoid spectrum aliasing of the predistorted signal u(n). Consequently, the linearization performance may be degraded compared to the embodiments shown in FIG. 3.

The predistortion system and the training and predistortion method disclosed herein may be integrated into transceiver devices, such base stations, small cells, user equipment (UE) (such as smartphones, tablets, and any equipment used for ultra-broadband wireless communication), and/or the like that may be used in 6G or future wireless communications for supporting ultra-fast data transmission, high-quality multimedia streaming, and low-latency connectivity.

For example, 6G networks usually need dense and massive deployments of small base stations for enhancing data rate and coverage. Thus, the number of radio-frequency PAs that are required to be linearized inevitably increases. The predistortion system and the training and predistortion method disclosed herein may be widely adopted to reduce the cost associated with small base-station deployment.

Herein, a cost-effective predistortion method is disclosed for PA linearization with reduced predistortion implementation cost, which may be achieved by lowering the ADC resolution and the sampling rates in the baseband module and the feedback loop. Specifically, the predistortion method disclosed herein uses a low-resolution and low-sampling-rate PA distortion estimation method to achieve sufficient PA estimation accuracy and linearization performance. Hardware complexity is controlled through segmented PA estimation augmented with asynchronous accumulation and averaging design. Thus, no additional hardware complexity is induced when a longer pseudo-preamble is used.

With the use of the low-resolution and low-sampling-rate PA distortion estimation method, the predistortion method disclosed herein also uses a PA-distortion-characteristics-specified multi-rate hybrid predistortion architecture to further mitigate the impact of low baseband sampling rate and provide sufficient linearization performance, which is achieved by tailoring different and specific sampling rates to the decomposition and elimination of PA static and dynamic distortions independently.

The above-described method applies to a wide range of communication networks, such as 5G+, 6G, WI-FI® (WI-FI is a registered trademark of Wi-Fi Alliance, Austin, TX, USA), base stations, access points, terrestrial networks (TNs), non-terrestrial networks (NTNs), distributed or self-organized networks, next-generation mobile and wireless network services, cloud and edge computing services, sensing services, and/or the like. The above-described method may be particularly useful for low-cost devices such as mobile phones, tablets, sensors, IoT devices, and/or the like.

The technical features and benefits of above-described embodiments may include:
Adaptive PA distortion estimation using pseudo-preamble with varying lengths, which mitigates the impact of low resolution and low feedback-loop sampling rate and providing sufficient PA estimation accuracy and linearization performance, and which significantly reduces hardware cost by reducing the feedback-loop sampling rate up to 100 times and ADC resolution bits to 3 to 4 bits. For example, in some embodiments, D₁=3 (compared to D₁=5 in prior art), D₂=2, D₃=100, and the ADC resolution is 3 to 4 bits (compared to 8 to 14 bits in prior art).
Hardware complexity control through segmented PA estimation augmented with asynchronous accumulation and averaging design, which would not increase hardware complexity when a longer pseudo-preamble is used.
New integrated multi-rate and hybrid predistortion adopting PA-distortion-characteristics-specified multi-rate assignment, which tailors different and specific sampling rates to the decomposition and elimination of PA static and dynamic distortions respectively, thereby mitigating the impact of the low baseband sampling rate and providing sufficient linearization performance.
Memoryless DPD with adaptive sampling rate, which achieves further reduced hardware cost by alleviating baseband sampling rate requirement from conventionally at least five (5) times of the original sampling rate to three (3) times of the original sampling rate.
Memory polynomial APD with adaptive sampling rate, which improves linearization performance. That is, as the memory polynomial function can be changed with different memory depths and order, the required sampling rate may also be adaptively changed. In other words, in some embodiments, the value of D₂ may not be a fixed value and may be changed adaptively based on the linearization performance requirement.

With the increase of frequency bands in wireless communications such as 6G mobile communications, the implementation cost of predistortion becomes unaffordable due to the exacerbated nonlinearities of PAs in wireless-communication devices. The predistortion method disclosed herein achieves cost-effective PA linearization with significantly reduced resolution and sampling rates, making it a promising solution for wireless communication systems such as 6G systems.

### B. Acronyms and Abbreviations

| Acronym/Abbreviation/ | |
|---|---|
| Initialism | Full Name |
| DPD | Digital Predistortion |
| APD | Analog Predistortion |
| PA | Power Amplifier |
| ADC | Analog-to-Digital Converter |
| TX | Transmitter Chain |
| 6G | Sixth Generation of Cellular Networks |
| mmWave | Millimeter wave |
| GHz | Gigahertz |
| THz | Terahertz |
| Gsps | Gigasamples per second |
| Msps | Megasamples per second |

### C. Definitions of Some Terms

Herein, the term “PA nonlinear distortions” refers to the deviations from linearity in the amplifier's response to input signals, which causes signal distortion and the generation of undesired harmonics and intermodulation products, thereby degrading the quality of the amplified signal in electronic and RF systems.

Herein, the term “predistortion” refers to a signal processing technique that intentionally applies distortion to an input signal to compensate for nonlinear distortions in amplification, resulting in a more linear output signal.

Herein, the term “multi-rate” refers to the simultaneous use of various sampling rates to accommodate the timing requirements of different components within a system.

Herein, the term “PA distortion estimation pseudo-preambles” or simply the “pseudo-preambles” refers to a PA-input pseudo-preamble and a PA-output pseudo-preamble. The PA-input pseudo-preamble refers to a known signal (that is, the PA input signal whose values or waveform is known) for inputting to the PA, and the PA-output pseudo-preamble is the PA output signal in accordance with the known PA input signal.

Herein, the pseudo-preambles include the PA-input pseudo-preamble and the PA-output pseudo-preamble.

Herein, the term “module” refers to a circuit or circuit unit for performing a specific function. A module may be implemented purely as hardware (such as an integrated circuit (IC) chip or a portion thereof), or as a mixture of hardware and software (such as an IC chip or a portion thereof that can execute instructions stored in a memory as software or firmware). Those skilled in the art understand that a module is often classified from the functionality point of view, and may be implemented as a single circuit (such as a single IC chip) or multiple chips (such as a one or more processor chips with one or more memory chips) functionally interconnected with each other. A module may comprise another module (also called “submodule”). Moreover, in various embodiments, there may exist various ways for module classification. In other words, multiple modules described in some embodiments may be classified as a single module in some other embodiments. Similarly, a module described in some embodiments may be classified as multiple modules in some other embodiments.

Herein, the term “predefined” (for example, a “predefined” item such as a “predefined” parameter) refers to an item defined before a certain event occurs or before a method is performed (for example, defined as a system design parameter, defined by relevant standards, and/or the like).

Herein, the term “preconfigured” (for example, a “preconfigured” item such as a “preconfigured” parameter) refers to an item configured, set up, or otherwise customized before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Those skilled in the art will appreciate that, in various embodiments, the methods disclosed herein may be implemented as hardware, software, firmware, or a combination thereof, and may be implemented in any suitable form.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A method for adaptively estimating a power amplifier distortion coefficients for compensating distortion of the power amplifier, the method comprising:
estimating the power-amplifier distortion coefficients based on a first digital signal for generating a radio-frequency analog signal through the power amplifier, and a second digital signal obtained from the radio-frequency analog signal;
wherein the first digital signal having a length adaptively variable based on a predefined distortion-estimation accuracy.

2. The method of claim 1, wherein said estimating the power-amplifier distortion coefficients comprising:
iteratively generating the first digital signal by asynchronously accumulating an adaptively selected first set of samples for providing an averaging effect to achieve desired the predefined distortion-estimation accuracy, the first set of samples being a first number of samples of the first digital signal.

3. The method of claim 1, wherein said estimating the power-amplifier distortion coefficients comprising:
downconverting the radio-frequency analog signal to a frequency lower than a carrier frequency of the radio-frequency analog signal to obtain a first analog signal;
converting the first analog signal to the second digital signal with a sampling rate lower than a full sampling rate;
estimating the power-amplifier distortion coefficients based on the first set of samples and a second set of samples, with the first set of samples being a first number of samples of the first digital signal and the second set of samples being the first number of samples of the second digital signal;
calculating an estimation error of the estimated power-amplifier distortion coefficients;
determining that the estimation error is larger than an estimation error threshold; and
repeating said estimating the power-amplifier distortion coefficients step based on the first set of samples and the second set of samples, with the first set of samples being a second number of samples of the first digital signal and the second set of samples being the second number of samples of the second digital signal, the second number being greater than the first number.

4. The method of claim 3, wherein the second number of samples of the first digital signal comprises the first number of samples of the first digital signal, and the second number of samples of the second digital signal comprises the first number of samples of the second digital signal.

5. The method of claim 3, wherein a ratio D₃ of the full sampling rate over the sampling rate of the second digital signal is greater than one.

6. The method of claim 3, wherein the first digital signal is obtained from a third digital signal; and
wherein the method further comprises:
generating an estimation of the second digital signal based on the first digital signal and the estimated power-amplifier distortion coefficients, and
training a plurality of predistortion coefficients based on comparison of the estimation of the second digital signal and the third digital signal.

7. The method of claim 6 further comprising:
adjusting a sampling rate of the estimation of the second digital signal to match a sampling rate of the third digital signal.

8. The method of claim 6, wherein the third digital signal is obtained by oversampling an input digital signal by a first oversampling factor D₁ lower than a Nyquist rate of the radio-frequency analog signal; and
wherein the method further comprises:
introducing digital predistortion into the third digital signal using a memoryless predistortion function with the plurality of predistortion coefficients to obtain the first digital signal,
oversampling the first digital signal by a second oversampling factor D₂ to obtain a fourth digital signal,
obtaining a second analog signal from the fourth digital signal,
upconverting the second analog signal to a radio frequency to obtain a third analog signal, and
introducing analog predistortion into the third analog signal using a memory polynomial predistortion function with the plurality of predistortion coefficients to obtain a fourth analog signal for inputting to the power-amplifier for obtaining the radio-frequency analog signal for transmission.

9. A module comprising:
one or more non-transitory computer-readable storage media; and
one or more processors functionally connected to the one or more non-transitory computer-readable storage media for:
estimating the power-amplifier distortion coefficients based on a first digital signal for generating a radio-frequency analog signal through the power amplifier, and a second digital signal obtained from the radio-frequency analog signal;
wherein the first digital signal having a length adaptively variable based on a predefined distortion-estimation accuracy.

10. The module of claim 9, wherein said estimating the power-amplifier distortion coefficients comprising:
iteratively generating the first digital signal by asynchronously accumulating an adaptively selected first set of samples for providing an averaging effect to achieve desired the predefined distortion-estimation accuracy, the first set of samples being a first number of samples of the first digital signal.

11. The module of claim 9, wherein said estimating the power-amplifier distortion coefficients comprising:
downconverting the radio-frequency analog signal to a frequency lower than a carrier frequency of the radio-frequency analog signal to obtain a first analog signal;
converting the first analog signal to the second digital signal with a sampling rate lower than a full sampling rate;
estimating the power-amplifier distortion coefficients based on the first set of samples and a second set of samples, with the first set of samples being a first number of samples of the first digital signal and the second set of samples being the first number of samples of the second digital signal;
calculating an estimation error of the estimated power-amplifier distortion coefficients;
determining that the estimation error is larger than an estimation error threshold; and
repeating said estimating the power-amplifier distortion coefficients step based on the first set of samples and the second set of samples, with the first set of samples being a second number of samples of the first digital signal and the second set of samples being the second number of samples of the second digital signal, the second number being greater than the first number.

12. The module of claim 11, wherein the second number of samples of the first digital signal comprises the first number of samples of the first digital signal, and the second number of samples of the second digital signal comprises the first number of samples of the second digital signal.

13. The module of claim 11, wherein a ratio D₃ of the full sampling rate over the sampling rate of the second digital signal is greater than one.

14. The module of claim 11, wherein the first digital signal is obtained from a third digital signal; and
wherein the one or more processors are further configured for:
generating an estimation of the second digital signal based on the first digital signal and the estimated power-amplifier distortion coefficients, and
training a plurality of predistortion coefficients based on comparison of the estimation of the second digital signal and the third digital signal.

15. The module of claim 14 wherein the one or more processors are further configured for:
adjusting a sampling rate of the estimation of the second digital signal to match a sampling rate of the third digital signal.

16. The module of claim 14, wherein the third digital signal is obtained by oversampling an input digital signal by a first oversampling factor D₁ lower than a Nyquist rate of the radio-frequency analog signal; and
wherein the one or more processors are further configured for:
introducing digital predistortion into the third digital signal using a memoryless predistortion function with the plurality of predistortion coefficients to obtain the first digital signal,
oversampling the first digital signal by a second oversampling factor D₂ to obtain a fourth digital signal,
obtaining a second analog signal from the fourth digital signal,
upconverting the second analog signal to a radio frequency to obtain a third analog signal, and
introducing analog predistortion into the third analog signal using a memory polynomial predistortion function with the plurality of predistortion coefficients to obtain a fourth analog signal for inputting to the power-amplifier for obtaining the radio-frequency analog signal for transmission.

17. One or more non-transitory computer-readable storage media comprising computer-executable instructions, wherein the instructions, when executed, cause one or more processors to perform actions comprising:
estimating the power-amplifier distortion coefficients based on a first digital signal for generating a radio-frequency analog signal through the power amplifier, and a second digital signal obtained from the radio-frequency analog signal;
wherein the first digital signal having a length adaptively variable based on a predefined distortion-estimation accuracy.

18. The one or more non-transitory computer-readable storage media of claim 17, wherein said estimating the power-amplifier distortion coefficients comprising:
iteratively generating the first digital signal by asynchronously accumulating an adaptively selected first set of samples for providing an averaging effect to achieve desired the predefined distortion-estimation accuracy, the first set of samples being a first number of samples of the first digital signal.

19. The one or more non-transitory computer-readable storage media of claim 17, wherein said estimating the power-amplifier distortion coefficients comprising:
downconverting the radio-frequency analog signal to a frequency lower than a carrier frequency of the radio-frequency analog signal to obtain a first analog signal;
converting the first analog signal to the second digital signal with a sampling rate lower than a full sampling rate;
estimating the power-amplifier distortion coefficients based on the first set of samples and a second set of samples, with the first set of samples being a first number of samples of the first digital signal and the second set of samples being the first number of samples of the second digital signal;
calculating an estimation error of the estimated power-amplifier distortion coefficients;
determining that the estimation error is larger than an estimation error threshold; and
repeating said estimating the power-amplifier distortion coefficients step based on the first set of samples and the second set of samples, with the first set of samples being a second number of samples of the first digital signal and the second set of samples being the second number of samples of the second digital signal, the second number being greater than the first number.

20. The one or more non-transitory computer-readable storage media of claim 17, wherein the second number of samples of the first digital signal comprises the first number of samples of the first digital signal, and the second number of samples of the second digital signal comprises the first number of samples of the second digital signal.
